(19) United States
(12) Patent Application Publication
(10) Pub. No.: US 2003/0015926 A1
(43) Pub. Date: Jan. 23, 2003

(54) Generator for producing high voltages

(76) Inventors: Richard Blatter, Schaffhausen (CH); Reinhard Joho, Rombach (CH)

Correspondence Address: SHANKS & HERBERT, 1033 N. FAIRFAX STREET, SUITE 306, ALEXANDRIA, VA, 22314, US

(21) Appl. No.: 10/199,021

(22) Filed: Jul. 22, 2002

(30) Foreign Application Priority Data
Jul. 23, 2001 (CH) 2001 1364/01

(51) Int. Cl. H02K 9/00; H02K 1/12

(52) U.S. Cl. 310/58; 310/254

(57) ABSTRACT

A generator (10) for producing high voltages comprises a rotor (12) which is mounted such that it can rotate about a rotation axis (18) and is surrounded by a stator (11), in whose laminated core (28) a stator winding (15) which is formed from insulated cables is arranged, which runs axially within the laminated core (28) and forms end windings (16) at the ends, outside the laminated core (28). In a generator such as this, the cooling is improved and the field control in and between the cables is simplified in that the stator (11) is accommodated with the laminated core (28) and the stator winding (15) in a housing (13) which is closed such that it is liquid-tight and has a cutout for the rotor (12), and in that the interior (14) of the housing (13) is filled with a cooling liquid.

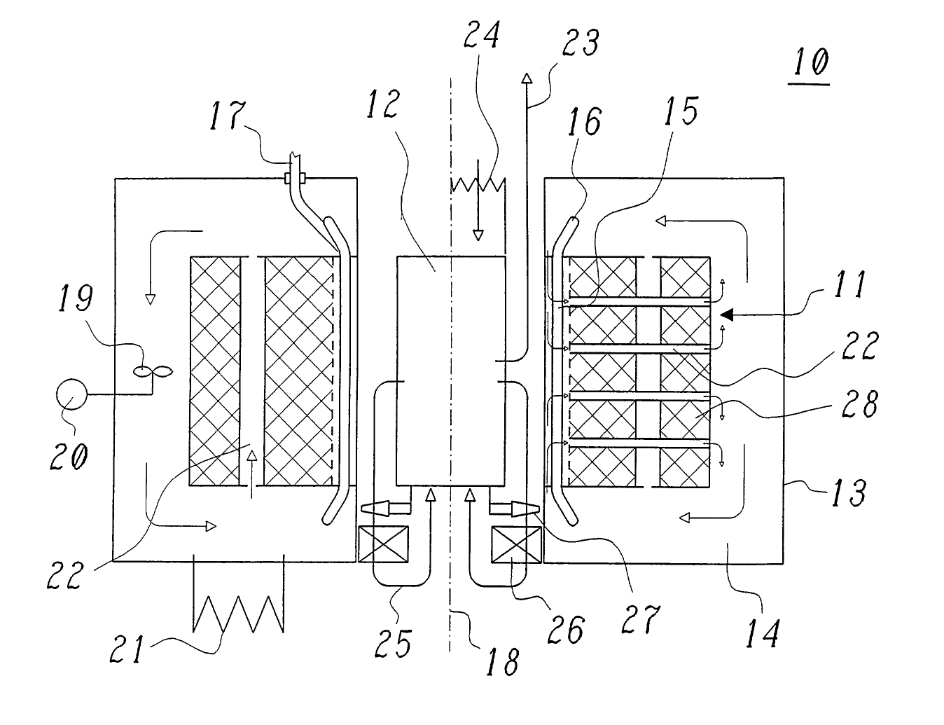

### TECHNICAL FIELD

The present invention relates to the field of electricity generation. It relates in particular to a generator for producing high voltages as claimed in the precharacterizing clause of claim 1. In this case, high voltages are regarded as those voltages which are above the normal 10 to 25 kV.

### PRIOR ART

One such generator is known, for example, from the document WO-A2-97/45919.

Generators having indirect liquid cooling on the stator side are known from the prior art, in which oil is used as the heat-carrying medium and as an insulating medium. Solutions such as these are described, by way of example, in the documents CH-A5-663120, DE-C2-29 15 390, and DE-A1-33 37 632.

Furthermore, cable-insulated generators are known, in which the stator conductor in the end winding is air-cooled, but the heat losses from the stator core are dissipated via a separate water circuit. In the case of generators with cables with grounded insulation in the generator winding, the field in the insulation is in this case controlled by a grounded semiconductive layer on the outer surface of the cable, (see, for example, the article by M. Leijon, Powerformer—a radically new rotating machine, ABB Review 2 (1998)).

These known cable-insulated generators are subject to the problem that the heat losses in the stator core and in the end windings are dissipated by different heat-carrying media. A further difficulty is uniform grounding of the field-controlling semiconductive layer on the cable winding, in order to ensure optimum field control.

### DESCRIPTION OF THE INVENTION

The object of the invention is thus to provide a cable-insulated generator which avoids the disadvantages of the known solutions and, in particular, allows continuous uniform cooling of the stator, and optimum field control for the cables in the stator winding.

The object is achieved by the totality of the features in claim 1. The essence of the invention is to accommodate the entire stator, with the laminated core and the stator winding (including the end windings), in a housing which is closed in a liquid-tight manner and has a cutout for the rotor, with the interior of the housing being filled with a cooling liquid. The cooling liquid carries out a number of main functions: the heat losses produced in the laminated core are dissipated via the surface of the laminated core (and possibly appropriately designed openings in the laminated core) through the circulating cooling liquid. The heat losses in the end winding are likewise dissipated via the cooling liquid. Both the insulated conductors and the stator core have a single cooling medium flowing around them, at a temperature which is as low as possible; there are no further thermal junctions having a power-limiting effect. The thermal storage capacity of the cooling liquid can have an advantageous effect on the short-term load rating of the generator; this is increased.

Water is preferably used as the cooling liquid, with means being provided to prevent corrosion of the laminated core of the stator. The corrosion-inhibiting means comprise, in particular, impregnation of the laminated core. However, a corrosion-inhibiting inhibitor can also be added to the water in the housing.

The cables of the stator winding preferably have solid insulation, and the cooling liquid has a predetermined electrical conductivity, in order to control the electric field and the field distribution in the insulation. There is therefore no longer any need for the cable insulation field to be controlled via a grounded semiconductor layer which is applied to the cable, and this can be done via the appropriately regulated electrical conductivity of the cooling liquid. The field distribution in the insulation thus becomes very homogeneous, since the potential on the cable surface is uniformly grounded (in the end winding, potential differences are effectively dissipated between the cable surfaces of crossing cables).

Special consideration must be given to any influence from the water on the insulation characteristics of the conductor cable. This can advantageously be achieved by impregnation of the surface semiconductor layer, and/or by the surface of the cable insulation of the stator winding being provided with a protective layer. This may be done, for example, by means of a silicone coating.

In principle, the cooling liquid (the water) will circulate automatically due to the non-uniform heat distribution in the housing. However, a circulation pump may also be provided in the housing, in order to increase the circulation of the cooling liquid.

The heat dissipation from the stator is further improved by providing additional openings, through which the cooling liquid flows, in the laminated core of the stator.

Heat is expediently extracted from the cooling liquid via a cooler.

Cable connections are preferably arranged outside the liquid area. For this purpose, the cables are passed out of the housing via sealing elements, which are known per se.

### BRIEF DESCRIPTION OF THE FIGURES

The invention will be explained in more detail in the following text with reference to exemplary embodiments and in conjunction with the drawing. The single FIGURE shows a simplified schematic illustration, in the form of a longitudinal section, of a generator according to one preferred exemplary embodiment of the invention.

### APPROACHES TO IMPLEMENTATION OF THE INVENTION

The FIGURE shows a simplified schematic illustration, in the form of a longitudinal section, of a generator 10 for producing high voltages, according to one preferred exemplary embodiment of the invention. The generator 10 has a (central) rotor 12, which is mounted such that it can rotate about a rotation axis 18 and is surrounded (coaxially) on the outside by a stator 11. The stator 11 essentially comprises a laminated core 28, with corresponding axial slots, in which a stator winding 15 is accommodated, which is formed from an insulated high-voltage cable. On each of the two end faces outside the laminated core 28, the stator winding 15 forms an end winding 16. Generator outgoers 17 are provided for outputting the high voltage which is induced in the stator winding 15.

The stator 11, together with the laminated core 28 and the stator winding 15 including the end windings 16, is arranged in a housing 13 which is sealed in a liquid-tight manner, and whose interior 14 is filled with treated water as the cooling liquid. Cooling liquids other than water may be used just as well. The housing 14 accommodates the rotor 12 and is likewise sealed with respect to the rotor, so that the rotor 12 can be operated with its own gas cooling. Such gas cooling may—as indicated by arrows in the FIGURE—either comprise a closed cooling circuit 25, which is kept in motion by a blade system 27 on the rotor 12 and dissipates the heat from the cooling medium by means of coolers 26 which are connected in the circuit (lower half of the rotor 12 in the FIGURE). However, an open cooling circuit 23 (open ventilation) may also be provided, in which the cooling medium, which flows in from the outside, is fed through appropriate filter mats 24 (upper half of the rotor 12 in the FIGURE).

The cooling liquid, water, which circulates in the interior 14 is preferably moved in the direction of the flow arrows by a circulation pump 19, which is driven by a drive motor 20, in order to ensure uniform, powerful circulation. The cooling liquid flows along the surfaces of the laminated core 28 and through the end windings 16 of the stator winding 15, as well as in the axial direction in the slots in the laminated core 28, along the axial sections (cables) of the stator winding 15. The heat dissipation from the laminated core 28 is further improved by providing additional openings 22 in the laminated core 28. The heat which is extracted from the cooling liquid is dissipated by means of a, preferably external, cooler 21. Instead of the openings 22, radial slots 22′ may also be used for circulation of the cooling liquid in the laminated core 28.

In addition, the iron part (the laminated core 28) of the stator 11 is impregnated such that it is not subject to corrosion by the cooling liquid; a corrosion-inhibiting inhibitor may also be added to the liquid in addition. The housing 13 is filled with treated water, whose electrical conductivity is set specifically. It is no longer absolutely essential for the field in the cable insulation in the stator winding 15 to be controlled—as in the prior art cited initially—via a grounded semiconductor layer which is applied to the cable, and this can be provided via the appropriately regulated electrical conductivity of the cooling liquid (of the water). In consequence, the field distribution in the insulation is highly homogeneous, since the cable surface is uniformly at ground potential. Special consideration must be given to the water influencing the insulation characteristics of the conductor cable, for example by means of a silicone layer on the cable surface.

### LIST OF REFERENCE SYMBOLS

10 Generator

11 Stator

12 Rotor

13 Housing (closed)

14 Interior (housing)

15 Stator winding (cable)

16 End winding

17 Generator outgoer

18 Rotation axis

19 Circulation pump

20 Drive motor

21 Cooler

22, 22′ Opening (in the laminated core)

23 Cooling circuit (open)

24 Filter mat

25 Cooling circuit (closed)

26 Cooler

27 Blade system

28 Laminated core (stator)

1. A generator (10) for producing high voltages, which generator (10) has a rotor (12) which is mounted such that it can rotate about a rotation axis (18) and is surrounded by a stator (11), in whose laminated core (28) a stator winding (15) which is formed from insulated cables is arranged, which runs axially within the laminated core (28) and forms end windings (16) at the ends, outside the laminated core (28), characterized in that the stator (11) is accommodated with the laminated core (28) and the stator winding (15) in a housing (13) which is closed such that it is liquid-tight and has a cutout for the rotor (12), and in that the interior (14) of the housing (13) is filled with a cooling liquid.

2. The generator as claimed in claim 1, characterized in that the cables of the stator winding (15) have solid insulation, and in that, in order to control the electric field and field distribution in the insulation, the cooling liquid has a predetermined electrical conductivity.

3. The generator as claimed in one of claims 1 or 2, characterized in that a circulation pump (19) is provided in order to increase the circulation of the cooling liquid in the housing (13).

4. The generator as claimed in one of claims 1 to 3, characterized in that additional openings (22, 22′), through which the cooling liquid flows, are provided in the laminated core (28) of the stator (11).

5. The generator as claimed in one of claims 1 to 4, characterized in that heat is extracted from the cooling liquid via a cooler (21).

6. The generator as claimed in one of claims 1 to 5, characterized in that water is used as the cooling liquid, and in that means are provided to prevent corrosion of the laminated core (28) of the stator (11).

7. The generator as claimed in claim 6, characterized in that the corrosion-inhibiting means comprise impregnation of the laminated core (28).

8. The generator as claimed in claim 6, characterized in that a corrosion-inhibiting inhibitor is added to the water in the housing (13).

9. The generator as claimed in claim 6, characterized in that the surface of the cable of the stator winding (15) is impregnated in order to prevent the ingress of water.
